(19) United States
(12) Patent Application Publication
(10) Pub. No.: US 2015/0362054 A1
(43) Pub. Date: Dec. 17, 2015

(54) TORQUE CONVERTER STATOR BLADE STRUCTURE

(71) Applicant: Allison Transmission, Inc., Indianapolis, IN (US)

(72) Inventors: John R. Murdock, Fishers, IN (US); Conrad L. Rockey, Indianapolis, IN (US); Michael Rietdorf, Fishers, IN (US)

(21) Appl. No.: 14/303,139

(22) Filed: Jun. 12, 2014

(51) Int. Cl. F16H 41/24

(52) U.S. Cl. CPC F16H 41/24; F16H 2041/246

(57) ABSTRACT

The present disclosure provides a blade of a stator assembly. The blade includes a body having a first end and a second end. A flow direction is defined normal to the first end. The blade also includes a leading edge defined at the first end and a trailing edge defined at the second end. A first curved surface and a second curved surface are formed between the leading edge and the trailing edge of the blade. A camber line is defined through the leading edge and the trailing edge. The camber line is oriented at a negative angle relative to the flow direction.

### FIELD OF THE DISCLOSURE

The present disclosure relates to a transmission system, and in particular to a stator design of a torque converter for the transmission system.

### BACKGROUND

A torque converter is a fluid coupling device that is used to transfer rotating power from a power unit, such as an engine or electric motor, to a power-transferring device such as a transmission. The transmission is an apparatus through which power and torque can be transmitted from a vehicle's power unit to a load-bearing device such as a drive axis. Conventional transmissions include a variety of gears, shafts, and clutches that transmit torque therethrough.

### SUMMARY

In one embodiment of the present disclosure, a stator assembly for a fluid-coupling device includes a housing; a one-way clutch coupled to the housing; and a plurality of blades coupled to the housing, each of the plurality of blades including a first end defining a leading edge of the blade and a second end defining a trailing edge thereof; wherein, a camber line defined between the leading edge and the trailing edge of each of the plurality of blades is oriented at a negative angle relative to a direction of flow.

In one example of this embodiment, each of the plurality of blades forms a convex-shaped surface on a pressure side of the blade. In a second example, each of the plurality of blades comprises a maximum thickness and a minimum thickness, a ratio of the maximum thickness to the minimum thickness being less than 3:1. In a third example, the ratio is between 2:1 and 3:1. In a fourth example, the ratio is approximately 2.2:1. In a fifth example, the trailing edge of each of the plurality of blades is blunt-shaped. In a sixth example, the trailing edge comprises a thickness that is less than 3 times thinner than a maximum thickness of each blade. In a further example, the thickness of the trailing edge is approximately 2-2.5 times thinner than the maximum thickness.

In another embodiment of this disclosure, a blade of a stator assembly includes a body having a first end and a second end, wherein a flow direction is normal to the first end; a leading edge defined at the first end; a trailing edge defined at the second end; a first curved surface and a second curved surface formed between the leading edge and the trailing edge; and a camber line defined through the leading edge and the trailing edge, wherein the camber line is oriented at a negative angle relative to the flow direction.

In one example of this embodiment, the first surface forms a convex-shaped surface on a pressure side of the blade. In a second example, the body comprises a maximum thickness and a minimum thickness between the first curved surface and the second curved surface; further wherein, a ratio of the maximum thickness to the minimum thickness is less than 3:1. In a third example, the ratio is between 2:1 and 3:1. In a fourth example, the trailing edge comprises a thickness that is less than 3 times thinner than the maximum thickness. In a fifth example, the thickness of the trailing edge is approximately 2-2.5 times thinner than the maximum thickness.

In a further embodiment, a fluid-coupling device for an automatic transmission includes an outer cover; a pump assembly including an outer shell fixedly coupled to the outer cover, a plurality of pump blades, a core ring, and a pump hub coupled to the outer shell, wherein the pump hub is adapted to be sealing engaged with the transmission; a turbine assembly including a shell, a core ring, and a plurality of turbine blades; and a stator assembly including a housing, a clutch coupled to the housing, and a plurality of stator blades coupled to the housing, wherein each of the plurality of stator blades includes a first end defining a leading edge of the blade and a second end defining a trailing edge thereof; further wherein, a direction of flow is defined normal to the leading edge, and a camber line is defined between the leading edge and the trailing edge of each of the plurality of stator blades, the camber line being oriented at a negative angle relative to the direction of flow.

In one example of this embodiment, each of the plurality of stator blades includes a first curved surface and a second curved surface formed between the leading edge and the trailing edge; further wherein, the first surface forms a convex-shaped surface on a pressure side of the blade. In a second example, each of the plurality of stator blades comprises a maximum thickness and a minimum thickness between the first curved surface and the second curved surface; further wherein, a ratio of the maximum thickness to the minimum thickness is less than 3:1. In a third example, the ratio is between 2:1 and 3:1. In a fourth example, the trailing edge comprises a thickness that is less than 3 times thinner than the maximum thickness. In a fifth example, the thickness of the trailing edge is approximately 2-2.5 times thinner than the maximum thickness.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is an exemplary block diagram and schematic view of one illustrative embodiment of a powered vehicular system;

FIG. 2 is a top half cross-sectional view of a conventional torque converter;

FIG. 3A is a top view of a conventional stator blade;

FIG. 3B is a top view of a negative rake stator blade as disclosed herein;

FIG. 4 is a plot of blade thickness of a conventional stator blade and k-factor of a pump;

FIG. 5 is a plot of blade thickness of a conventional stator blade and torque ratio;

FIG. 6 is a plot of blade thickness of a conventional stator blade and maximum blade deflection;

FIG. 7 is a plot of speed ratio and torque ratio for a negative rake stator blade; and

FIG. 8 is a plot of speed ratio and k-factor of a pump for a negative rake stator blade.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

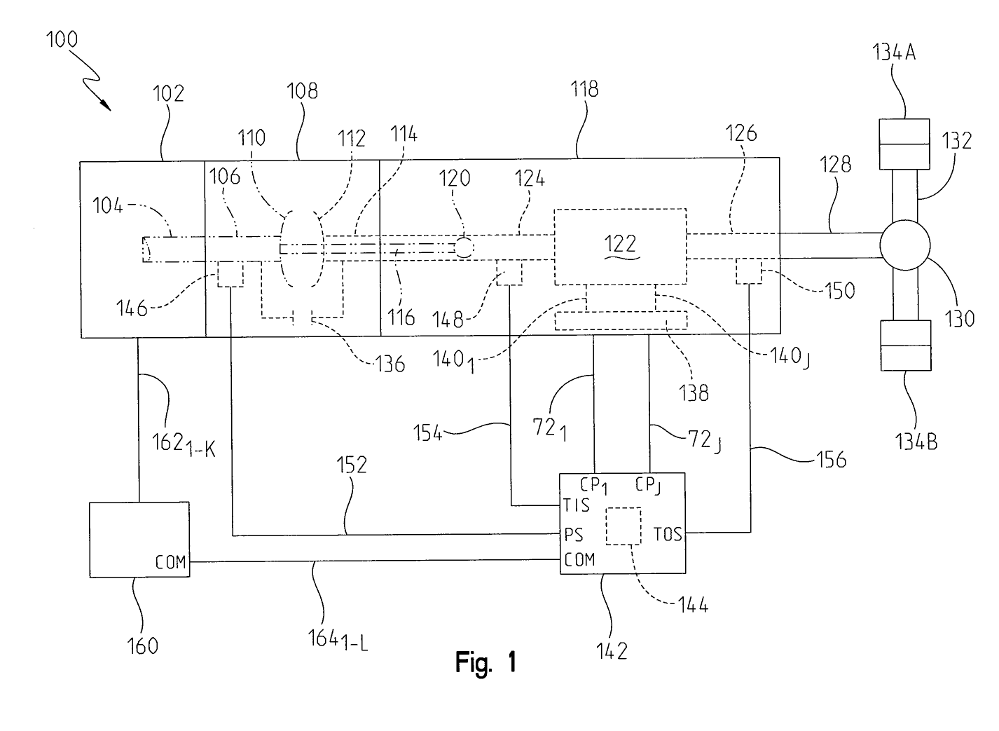

Referring now to FIG. 1, a block diagram and schematic view of one illustrative embodiment of a vehicular system 100 having a drive unit 102 and transmission 118 is shown. In the illustrated embodiment, the drive unit 102 may include an internal combustion engine, diesel engine, electric motor, or other power-generating device. The drive unit 102 is configured to rotatably drive an output shaft 104 that is coupled to an input or pump shaft 106 of a conventional torque converter 108. The input or pump shaft 106 is coupled to an impeller or pump 110 that is rotatably driven by the output shaft 104 of the drive unit 102. The torque converter 108 further includes a turbine 112 that is coupled to a turbine shaft 114, and the turbine shaft 114 is coupled to, or integral with, a rotatable input shaft 124 of the transmission 118. The transmission 118 can also include an internal pump 120 for building pressure within different flow circuits (e.g., main circuit, lube circuit, etc.) of the transmission 118. The pump 120 can be driven by a shaft 116 that is coupled to the output shaft 104 of the drive unit 102. In this arrangement, the drive unit 102 can deliver torque to the shaft 116 for driving the pump 120 and building pressure within the different circuits of the transmission 118.

The transmission 118 can include a planetary gear system 122 having a number of automatically selected gears. An output shaft 126 of the transmission 118 is coupled to or integral with, and rotatably drives, a propeller shaft 128 that is coupled to a conventional universal joint 130. The universal joint 130 is coupled to, and rotatably drives, an axle 132 having wheels 134A and 134B mounted thereto at each end. The output shaft 126 of the transmission 118 drives the wheels 134A and 134B in a conventional manner via the propeller shaft 128, universal joint 130 and axle 132.

A conventional lockup clutch 136 is connected between the pump 110 and the turbine 112 of the torque converter 108. The operation of the torque converter 108 is conventional in that the torque converter 108 is operable in a so-called “torque converter” mode during certain operating conditions such as vehicle launch, low speed and certain gear shifting conditions. In the torque converter mode, the lockup clutch 136 is disengaged and the pump 110 rotates at the rotational speed of the drive unit output shaft 104 while the turbine 112 is rotatably actuated by the pump 110 through a fluid (not shown) interposed between the pump 110 and the turbine 112. In this operational mode, torque multiplication occurs through the fluid coupling such that the turbine shaft 114 is exposed to drive more torque than is being supplied by the drive unit 102, as is known in the art. The torque converter 108 is alternatively operable in a so-called “lockup” mode during other operating conditions, such as when certain gears of the planetary gear system 122 of the transmission 118 are engaged. In the lockup mode, the lockup clutch 136 is engaged and the pump 110 is thereby secured directly to the turbine 112 so that the drive unit output shaft 104 is directly coupled to the input shaft 124 of the transmission 118, as is also known in the art.

The transmission 118 further includes an electro-hydraulic system 138 that is fluidly coupled to the planetary gear system 122 via a number, J, of fluid paths, 140₁-140_{J}, where J may be any positive integer. The electro-hydraulic system 138 is responsive to control signals to selectively cause fluid to flow through one or more of the fluid paths, 140₁-140_{J}, to thereby control operation, i.e., engagement and disengagement, of a plurality of corresponding friction devices in the planetary gear system 122. The plurality of friction devices may include, but are not limited to, one or more conventional brake devices, one or more torque transmitting devices, and the like. Generally, the operation, i.e., engagement and disengagement, of the plurality of friction devices is controlled by selectively controlling the friction applied by each of the plurality of friction devices, such as by controlling fluid pressure to each of the friction devices. In one example embodiment, which is not intended to be limiting in any way, the plurality of friction devices include a plurality of brake and torque transmitting devices in the form of conventional clutches that may each be controllably engaged and disengaged via fluid pressure supplied by the electro-hydraulic system 138. In any case, changing or shifting between the various gears of the transmission 118 is accomplished in a conventional manner by selectively controlling the plurality of friction devices via control of fluid pressure within the number of fluid paths 140₁-140_{J}.

The system 100 further includes a transmission control circuit 142 that can include a memory unit 144. The transmission control circuit 142 is illustratively microprocessor-based, and the memory unit 144 generally includes instructions stored therein that are executable by a processor of the transmission control circuit 142 to control operation of the torque converter 108 and operation of the transmission 118, i.e., shifting between the various gears of the planetary gear system 122. It will be understood, however, that this disclosure contemplates other embodiments in which the transmission control circuit 142 is not microprocessor-based, but is configured to control operation of the torque converter 108 and/or transmission 118 based on one or more sets of hardwired instructions and/or software instructions stored in the memory unit 144.

In the system 100 illustrated in FIG. 1, the torque converter 108 and the transmission 118 include a number of sensors configured to produce sensor signals that are indicative of one or more operating states of the torque converter 108 and transmission 118, respectively. For example, the torque converter 108 illustratively includes a conventional speed sensor 146 that is positioned and configured to produce a speed signal corresponding to the rotational speed of the pump shaft 106, which is the same rotational speed of the output shaft 104 of the drive unit 102. The speed sensor 146 is electrically connected to a pump speed input, PS, of the transmission control circuit 142 via a signal path 152, and the transmission control circuit 142 is operable to process the speed signal produced by the speed sensor 146 in a conventional manner to determine the rotational speed of the turbine shaft 106/drive unit output shaft 104.

The transmission 118 illustratively includes another conventional speed sensor 148 that is positioned and configured to produce a speed signal corresponding to the rotational speed of the transmission input shaft 124, which is the same rotational speed as the turbine shaft 114. The input shaft 124 of the transmission 118 is directly coupled to, or integral with, the turbine shaft 114, and the speed sensor 148 may alternatively be positioned and configured to produce a speed signal corresponding to the rotational speed of the turbine shaft 114. In any case, the speed sensor 148 is electrically connected to a transmission input shaft speed input, TIS, of the transmission control circuit 142 via a signal path 154, and the transmission control circuit 142 is operable to process the speed signal produced by the speed sensor 148 in a conventional manner to determine the rotational speed of the turbine shaft 114/transmission input shaft 124.

The transmission 118 further includes yet another speed sensor 150 that is positioned and configured to produce a speed signal corresponding to the rotational speed of the output shaft 126 of the transmission 118. The speed sensor 150 may be conventional, and is electrically connected to a transmission output shaft speed input, TOS, of the transmission control circuit 142 via a signal path 156. The transmission control circuit 142 is configured to process the speed signal produced by the speed sensor 150 in a conventional manner to determine the rotational speed of the transmission output shaft 126.

In the illustrated embodiment, the transmission 118 further includes one or more actuators configured to control various operations within the transmission 118. For example, the electro-hydraulic system 138 described herein illustratively includes a number of actuators, e.g., conventional solenoids or other conventional actuators, that are electrically connected to a number, J, of control outputs, CP₁-CP_{J}, of the transmission control circuit 142 via a corresponding number of signal paths 72₁-72_{J}, where J may be any positive integer as described above. The actuators within the electro-hydraulic system 138 are each responsive to a corresponding one of the control signals, CP₁-CP_{J}, produced by the transmission control circuit 142 on one of the corresponding signal paths 72₁-72J to control the friction applied by each of the plurality of friction devices by controlling the pressure of fluid within one or more corresponding fluid passageway 140₁-140_{J}, and thus control the operation, i.e., engaging and disengaging, of one or more corresponding friction devices, based on information provided by the various speed sensors 146, 148, and/or 150.

The friction devices of the planetary gear system 122 are illustratively controlled by hydraulic fluid which is distributed by the electro-hydraulic system in a conventional manner. For example, the electro-hydraulic system 138 illustratively includes a conventional hydraulic positive displacement pump (not shown) which distributes fluid to the one or more friction devices via control of the one or more actuators within the electro-hydraulic system 138. In this embodiment, the control signals, CP₁-CP_{J}, are illustratively analog friction device pressure commands to which the one or more actuators are responsive to control the hydraulic pressure to the one or more frictions devices. It will be understood, however, that the friction applied by each of the plurality of friction devices may alternatively be controlled in accordance with other conventional friction device control structures and techniques, and such other conventional friction device control structures and techniques are contemplated by this disclosure. In any case, however, the analog operation of each of the friction devices is controlled by the control circuit 142 in accordance with instructions stored in the memory unit 144.

In the illustrated embodiment, the system 100 further includes a drive unit control circuit 160 having an input/output port (I/O) that is electrically coupled to the drive unit 102 via a number, K, of signal paths 162, wherein K may be any positive integer. The drive unit control circuit 160 may be conventional, and is operable to control and manage the overall operation of the drive unit 102. The drive unit control circuit 160 further includes a communication port, COM, which is electrically connected to a similar communication port, COM, of the transmission control circuit 142 via a number, L, of signal paths 164, wherein L may be any positive integer. The one or more signal paths 164 are typically referred to collectively as a data link. Generally, the drive unit control circuit 160 and the transmission control circuit 142 are operable to share information via the one or more signal paths 164 in a conventional manner. In one embodiment, for example, the drive unit control circuit 160 and transmission control circuit 142 are operable to share information via the one or more signal paths 164 in the form of one or more messages in accordance with a society of automotive engineers (SAE) J-1939 communications protocol, although this disclosure contemplates other embodiments in which the drive unit control circuit 160 and the transmission control circuit 142 are operable to share information via the one or more signal paths 164 in accordance with one or more other conventional communication protocols (e.g., from a conventional databus such as J1587 data bus, J1939 data bus, IESCAN data bus, GMLAN, Mercedes PT-CAN).

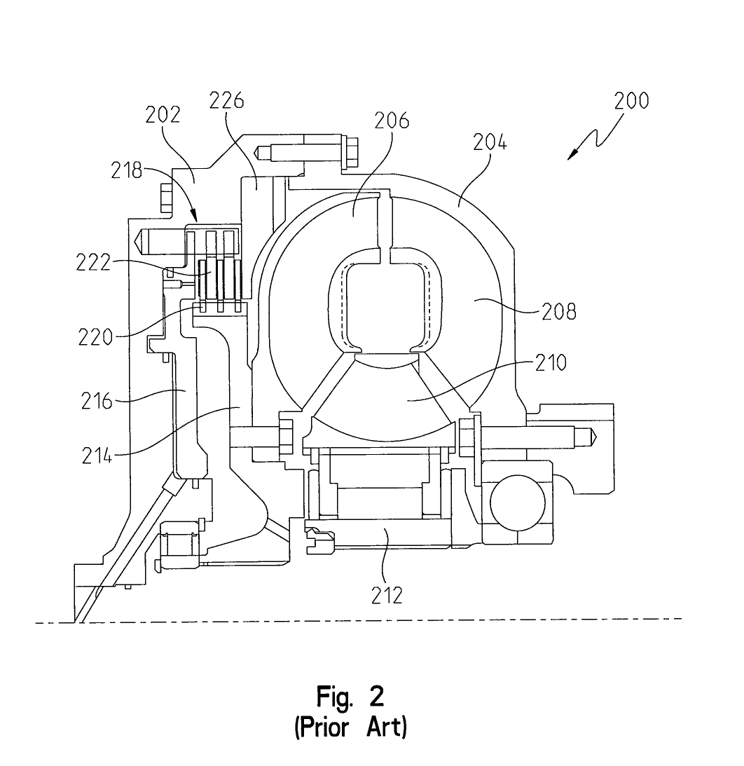

Referring to FIG. 2, one embodiment is shown of a top half, cross-sectional view of a conventional torque converter 200. Torque converter 200 includes a front cover assembly 202 fixedly attached to a rear cover 204 or shell at a coupled location. In one example, the coupled location can include a bolted joint, a welded joint, or any other type of coupling means. The converter 200 includes a turbine assembly 206 with turbine blades, a shell, and a core ring. The converter 200 also includes a pump assembly 208 with impellor or pump blades, an outer shell, and a core ring.

A stator assembly 210 is axially disposed between the pump assembly 208 and the turbine assembly 206. The stator assembly 210 can includes a housing, one or more stator blades, and a one-way clutch 212. The one-way clutch 212 may be a roller or sprag design as is commonly known in the art.

The torque converter 200 can include a clutch assembly 218 that transmits torque from the front cover 202 to a turbine hub 214. The clutch assembly 218 includes a piston plate 216, a backing plate 226, a plurality of clutch plates 220, and a plurality of reaction plates 222. The plurality of clutch plates 220 and reaction plates 222 can be splined to the turbine hub 214, which is bolted to a turbine assembly as shown in FIG. 2. The piston plate 216 can be hydraulically actuated to engage and apply the clutch assembly 218, thereby “hydraulically coupling” the turbine assembly 206 and pump assembly 208 to one another. Hydraulic fluid can flow through a dedicated flow passage in the torque converter 200 on a front side of the piston plate 216 to urge the plate 216 towards and into engagement with the clutch assembly 218. One skilled in the art can appreciate how this and other designs of fluid-coupling devices can be used for fluidly coupling an engine and transmission to one another.

The embodiments of FIGS. 1 and 2 therefore provide illustrative examples of a fluid coupling device such as a torque converter operably driving a conventional transmission. FIG. 2, in particular, provides an illustrative example of a conventional torque converter. In the example of FIG. 2, the converter 200 is described as including a stator assembly 210. As known to those skilled in the art, a stator or stator assembly is incorporated into the design of a torque converter for purposes of achieving torque multiplication. Although not shown in FIG. 2, the stator assembly can include a plurality of blades or ports used to redirect the flow of fluid therethrough to change torque ratio. Without a stator, the conventional torque converter would have a 1:1 torque ratio across all speed ratios, which would be representative of a maximum pump capacity.

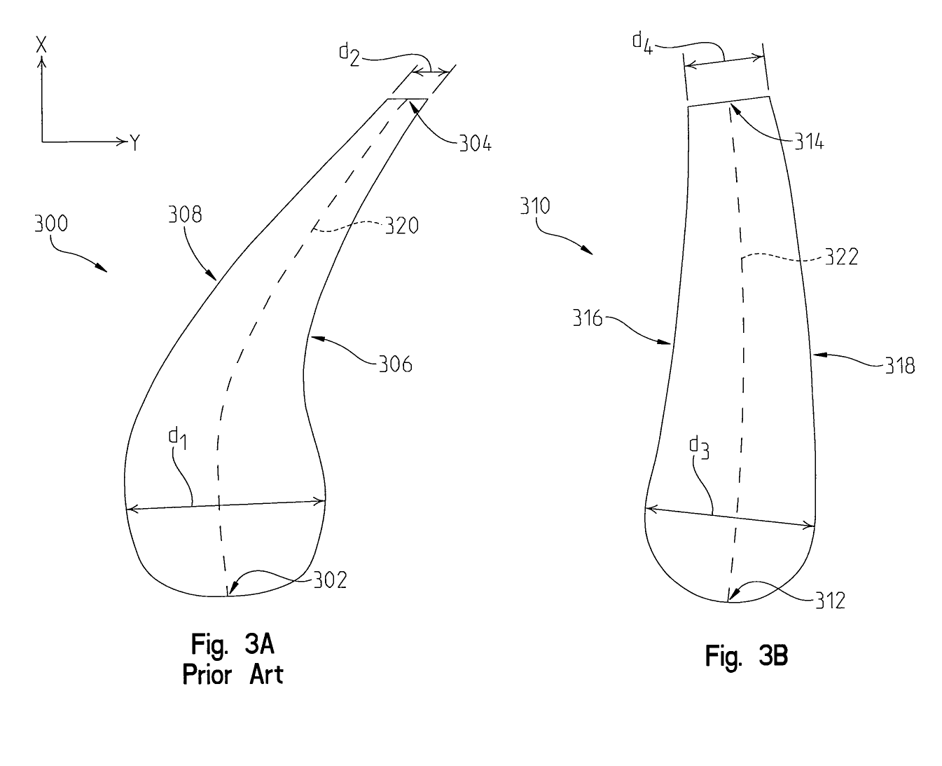

Referring to FIG. 3, one example of a conventional stator blade 300 is shown. The blade 300 is a structure that can be defined by one or more curved surfaces that extend from a first end to a second end. In FIG. 3, a first end is referred to as a leading edge 302 of the blade 300. Moreover, a second end is referred to as a trailing edge 304 of the blade 300. During operation, a flow direction is oriented in the x-direction as shown in FIG. 3. In other words, the flow direction is in the direction from the leading edge 302 to the trailing edge 304 of the blade 300.

As previously described, the blade 300 in FIG. 3 is representative of a conventional, positive angle stator blade. Stator blades are designed and manufactured as positive angle blades for efficiency reasons. The blade 300 is shaped such that the trailing edge 304 is oriented towards or in a y-direction, as shown in FIG. 3 (i.e., towards the right). In addition, the blade 300 includes a first curved surface 306 and a second curved surface 308. The first curved surface 306 is concave, which is also representative of a conventional, positive angle stator blade. The first curved surface 306 also forms the pressure side of the blade 300.

In FIG. 3, the stator blade also varies in thickness between the leading edge 302 and the trailing edge 304. As shown, the blade 300 can have a maximum thickness represented by thickness, d1. In addition, near the trailing edge 304, the blade 300 can include a minimum thickness, d2. In most applications, a conventional stator blade may have a thickness ratio between the maximum and minimum thicknesses of between about 4:1 and 7:1. In some aspects, this ratio may be as low as 3:1, and in other aspects greater than 7:1. Due to the higher ratio, the conventional stator blade 300 can have a more pointed end near the trailing edge 304, which can facilitate flow about the blade 300.

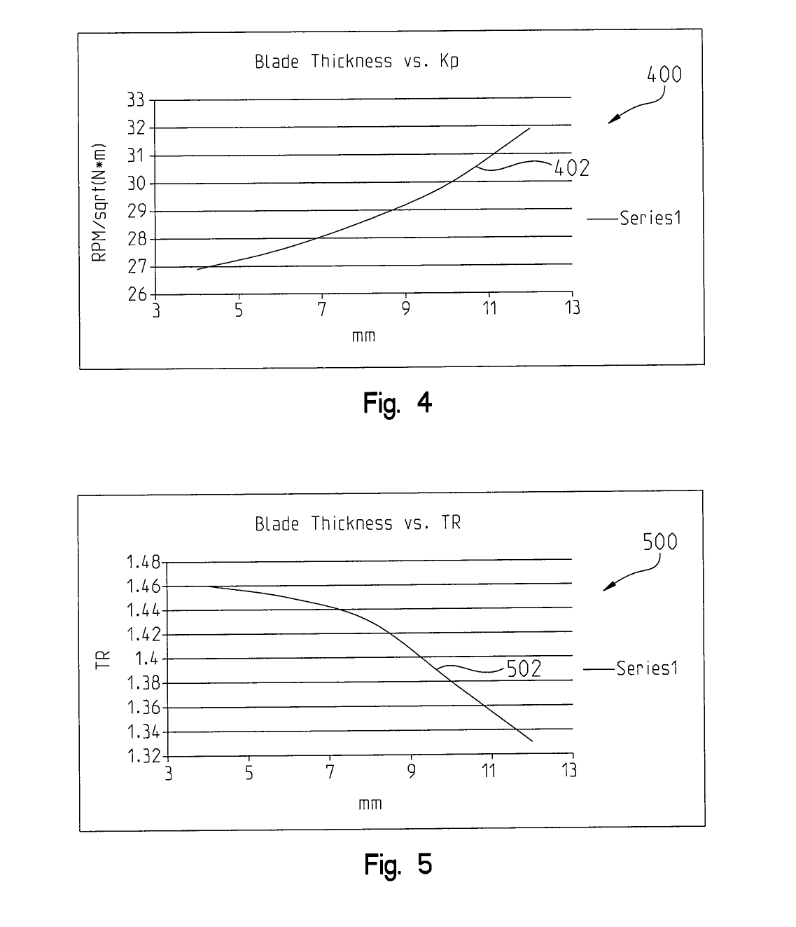

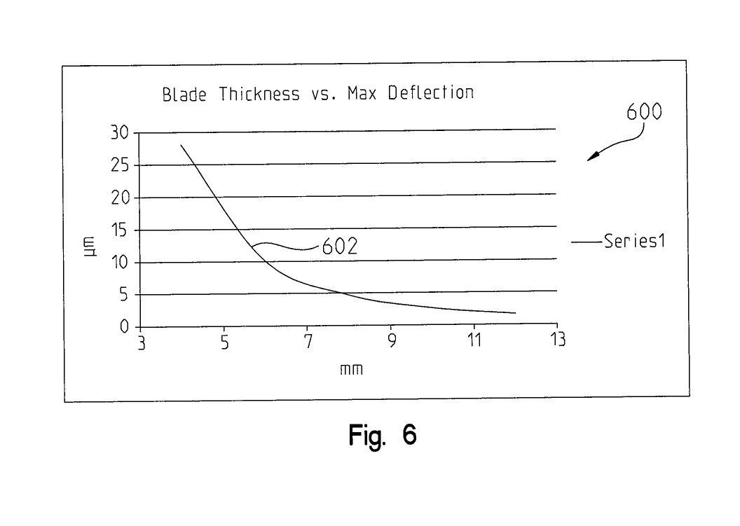

In FIGS. 4-6, a plurality of characteristics of a conventional, positive angle stator blade is illustrated relative to blade thickness. As shown in FIG. 4, a first illustration 400 shows the relationship between blade thickness and Kp. Kp refers to a k-factor of the pump that forms part of the torque converter. Kp is also referred to as the inverse of pump capacity. With a conventional, positive angle stator blade 300, Kp generally increases as blade thickness increases. In this illustration 400, a curve 402 representative of the relationship of Kp to blade thickness shows the increase in Kp as blade thickness increases. Moreover, the illustration is provided based on scaling of points along the blade 300 by the same factor to increase blade thickness. This same metric is considered in FIGS. 5 and 6 as well.

Referring to FIG. 5, for example, blade thickness is plotted relative to torque ratio, TR. In this illustration 500, a curve 502 representative of this relationship shows that torque ratio decreases for a conventional, positive angle stator blade 300 as its thickness increases. Similarly, in FIG. 6, an illustration 600 provides a curve 602 that shows the relationship between blade thickness and maximum deflection. In some engineering applications, engineering strength can be defined as the ability of an object or material to resist deformation or deflection. As expected in a conventional stator blade 300, maximum deflection decreases as the blade thickness increases. This illustrates a thicker blade can provide better structural integrity by increasing its thickness.

As suggested in FIGS. 4-6, as a conventional, positive angle stator blade 300 is thickened and/or its angle is increased relative to the direction of flow (e.g., +x-direction in FIG. 3), torque ratio and Kp increase. In a conventional torque converter, Kp is often desired in the range of 50-250 and torque ratio at stall is between 1.8-2.3. In addition, the positive angle stator blade is often measured based off a camber line 320 in direction of flow that passes through the leading edge 302 and trailing edge 304 of the blade 300. As previously described, the thickness of the blade 300 near the trailing edge of a conventional, positive angle blade 300 is usually desirably narrow to allow fluid flowing along the first surface 306 and the second surface 308 to more easily rejoin at the trailing edge 304 without the flow becoming turbulent. This can desirably avoid turbulent losses, no low pressure zones around the blade, and no recirculation of flow. In other words, the design of the blade 300 can provide better flow and operating efficiency of the blade 300. For purposes of example only, a conventional, positive angle stator blade 300 can have an angle of approximately 30-75°.

Efficiency can be a measurement of torque ratio and speed ratio. Speed ratio is a value between 0 and 1, and therefore as torque ratio increases the efficiency likewise increases. For customers that desire greater fuel economy, a more efficient design is desirable and thus conventional stators are designed with a positive angle stator blade 300 as shown in FIG. 3.

However, in some limited applications, efficiency may not be as important as higher horsepower. In fracking and drilling applications, for example, customers often desire greater power performance from their machines or vehicles. It is in these applications that the present disclosure provides an alternative design to the conventional stator. For instance, some applications may require a transmission that can withstand 2500 or more horsepower to perform a desired task. In these applications, automated manual and manual transmissions are unable to withstand the power and torque requirements. Moreover, these transmissions often do not include a torque converter or other fluid-coupling device.

In an automatic transmission that includes a fluid-coupling device, one embodiment of a stator blade 310 is shown in FIG. 3. Unlike the conventional stator blade 300, the alternative blade 310 is designed as a negative rake blade. Here, the torque converter can remain the same as a conventional torque converter by using the same pump and turbine. This can be advantageous for cost reasons. In addition, the blade 310 does not introduce any additional space constraints or require any recasting of the blades. In this design, the pump and turbine can be designed to their relative maximum practical angles (e.g., pump maximum entry angle can be between 60-65° and turbine maximum exit angle can be between −65° and −75°). It has been found that beyond these angles there is a loss of efficiency, torque ratio, and pump capacity. Therefore, once the pump entry angle is at or near a maximum angle and the turbine exit angle is at or near a maximum angle, the only remaining change for the higher power application is to modify the design of the stator blades or increase the outer diameter of the pump and turbine, which can be detrimental due to a cost increase and space constraint.

In one higher power application, it may be desirable to produce greater pump capacity, which results in a lower Kp factor in the range of approximately 18-21 for most speed ratios. In this application, torque ratio may not be as important but it may still be desirable to maintain or reduce torque ratio to between 1.3-1.4 at or near a stall condition (i.e., when speed ratio is zero). Therefore, in order to meet these requirements of a higher horsepower application, a conventional stator assembly can be redesigned to reduce the number of stator blades, increase blade thickness of each stator blade, and modify each stator blade to a negative rake design as represented by the stator blade 310 in FIG. 3.

In the modified stator, a reduction in the number of stator blades can reduce a flow restriction through the stator. In conventional stator assemblies, it is often desirable to increase the number of blades to increase the structural integrity of the stator. Again, however, this is ideal for applications that desire greater efficiency. In the present disclosure, higher power applications require structural integrity among other things. To achieve the desired structural integrity, each blade can be thickened. This can be further seen in FIG. 3.

Referring to FIG. 3, the negative rake stator blade 310 can include a leading edge 312 and a trailing edge 314. The blade 310 also includes a first surface 316 and a second surface 318. The pressure side of the stator blade 310, i.e., formed by the second surface 318, is convex-shaped. Moreover, the trailing edge 314 is oriented at a negative angle relative to its camber line 322 and flow direction.

The modified stator blade 310 can also have an increased overall thickness and a blunt trailing edge 314, both of which are counterintuitive and contrary to most conventional stator blades. This design allows the stator blade sufficient structural integrity to withstand fluid forces in the higher power application. As an example, the modified blade 310 can include a maximum thickness, d3, and a minimum thickness, d4, at the trailing edge 314. In one aspect, it may be desirable for the ratio of thicknesses of the modified blade 310 to be approximately 2:1. In another aspect, this ratio may be desirable around 2.2:1. In any event, most aspects of this modified design include a ratio less than 2.5:1.

It is also worth noting that simply increasing blade thickness of a conventional stator blade 300 often results in about 10% increase in both Kp and torque ratio. Unlike the conventional blades, however, the modified blade 310 can be thickened and produce a lower Kp and torque ratio. The lower Kp and torque ratio are necessary in order to make the modified torque converter (and transmission) compatible with most conventional engines. A higher Kp or torque ratio would have resulted in an incompatibility between the engine and transmission.

As for the trailing edge 314, it can be desirable to form the blade 310 such that it includes a blunt trailing edge, rather than a narrow or pointed trailing edge 304 as in the conventional blade 300. Here, the blunt trailing edge can have a thickness of approximately 2.2 times thinner than its thickest part, whereas a conventional stator blade often includes a trailing edge having a thickness of approximately 4-7 times thinner than its thickest part.

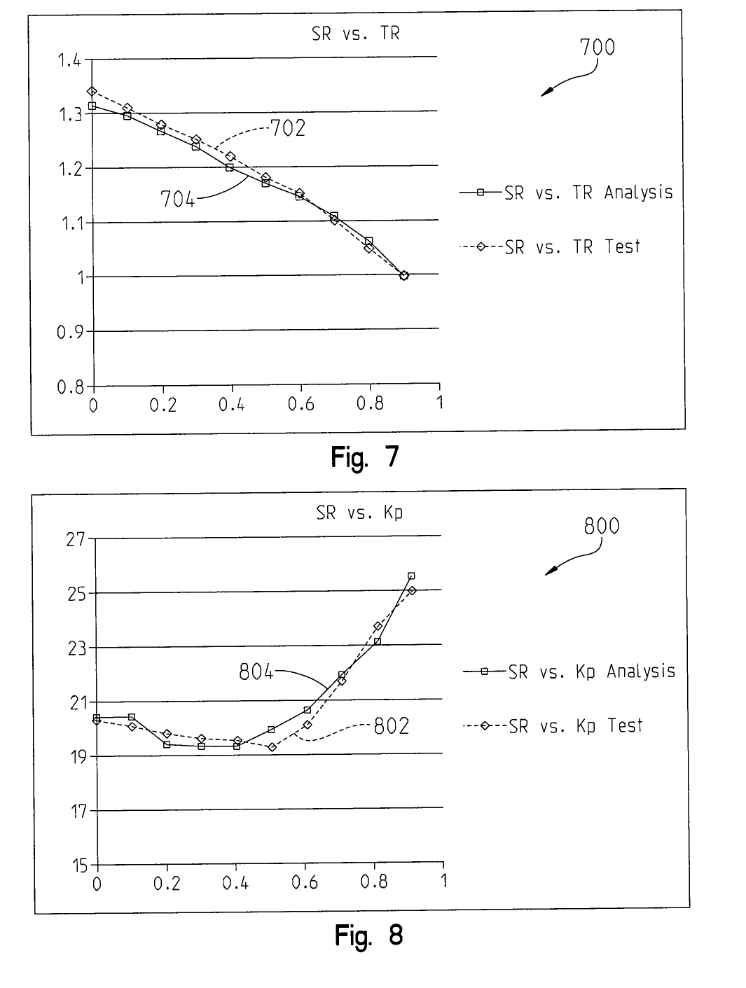

Referring to FIG. 7, a graphical illustration 700 includes a first curve 702 and a second curve 704 representative of the relationship between speed ratio and torque ratio for a negative rake or negative angle stator blade. As previously described, in the higher power applications for which the modified stator blade 310 is designed for, it is desirable to have a torque ratio of at least 1.2 at stall (i.e., at a speed ratio of 0) and maintain the torque ratio at less than 1.4 for all speed ratios. As shown in FIG. 7, the first curve 702 represents an analytical study of the relationship between speed ratio and torque ratio utilizing a negative angle blade, and the second curve 704 represents actual test results of a negative angle stator blade. As shown, the torque ratio is less than that for a conventional stator blade at stall (i.e., less than 1.4 whereas a conventional blade is approximately 1.8-2.3), and torque ratio remains low across all speed ratios. This, of course, in most applications is undesirable because it directly represents a reduction in efficiency.

Referring to FIG. 8, another illustration 800 includes a first curve 802 and a second curve 804. The first curve 802 is representative of analytical data and the second curve is representative of actual test data. In each case, the curves represent the relationship between speed ratio and Kp for a negative angle stator blade. As previously described, for the higher horsepower applications (e.g., 2500 hp and greater) it is desirable to reduce the Kp factor to between 18-21 across most speed ratios. As shown, the Kp factor is in fact at or below 21 for speed ratios between about 0 and 0.6.

Therefore, the embodiments of this disclosure provide a modified stator assembly with negative angle stator blades that include an increased thickness and a blunt trailing edge. It may also be desirable to limit the number of stator blades to approximately 23 or less for a given stator assembly in order to meet flow requirements through the stator.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A stator assembly for a fluid-coupling device, comprising:
a housing;
a one-way clutch coupled to the housing; and
a plurality of blades coupled to the housing, each of the plurality of blades including a first end defining a leading edge of the blade and a second end defining a trailing edge thereof;
wherein, a camber line defined between the leading edge and the trailing edge of each of the plurality of blades is oriented at a negative angle relative to a direction of flow.

2. The stator assembly of claim 1, wherein each of the plurality of blades forms a convex-shaped surface on a pressure side of the blade.

3. The stator assembly of claim 1, wherein each of the plurality of blades comprises a maximum thickness and a minimum thickness, a ratio of the maximum thickness to the minimum thickness being less than 3:1.

4. The stator assembly of claim 3, wherein the ratio is between 2:1 and 3:1.

5. The stator assembly of claim 3, wherein the ratio is approximately 2.2:1.

6. The stator assembly of claim 1, wherein the trailing edge of each of the plurality of blades is blunt-shaped.

7. The stator assembly of claim 6, wherein the trailing edge comprises a thickness that is less than 3 times thinner than a maximum thickness of each blade.

8. The stator assembly of claim 7, wherein the thickness of the trailing edge is approximately 2-2.5 times thinner than the maximum thickness.

9. A blade of a stator assembly, comprising:
a body having a first end and a second end, wherein a flow direction is normal to the first end;
a leading edge defined at the first end;
a trailing edge defined at the second end;
a first curved surface and a second curved surface formed between the leading edge and the trailing edge; and
a camber line defined through the leading edge and the trailing edge, wherein the camber line is oriented at a negative angle relative to the flow direction.

10. The blade of claim 9, wherein the second surface forms a convex-shaped surface on a pressure side of the blade.

11. The blade of claim 9, wherein the body comprises a maximum thickness and a minimum thickness between the first curved surface and the second curved surface;
further wherein, a ratio of the maximum thickness to the minimum thickness is less than 3:1.

12. The blade of claim 11, wherein the ratio is between 2:1 and 3:1.

13. The blade of claim 11, wherein the trailing edge comprises a thickness that is less than 3 times thinner than the maximum thickness.

14. The blade of claim 11, wherein the thickness of the trailing edge is approximately 2-2.5 times thinner than the maximum thickness.

15. A fluid-coupling device for an automatic transmission, comprising:
an outer cover;
a pump assembly including an outer shell fixedly coupled to the outer cover, a plurality of pump blades, a core ring, and a pump hub coupled to the outer shell, wherein the pump hub is adapted to be sealing engaged with the transmission;
a turbine assembly including a shell, a core ring, and a plurality of turbine blades; and
a stator assembly including a housing, a clutch coupled to the housing, and a plurality of stator blades coupled to the housing, wherein each of the plurality of stator blades includes a first end defining a leading edge of the blade and a second end defining a trailing edge thereof;
further wherein, a direction of flow is defined normal to the leading edge, and a camber line is defined between the leading edge and the trailing edge of each of the plurality of stator blades, the camber line being oriented at a negative angle relative to the direction of flow.

16. The fluid-coupling device of claim 15, wherein each of the plurality of stator blades comprises a first curved surface and a second curved surface formed between the leading edge and the trailing edge;
further wherein, the second surface forms a convex-shaped surface on a pressure side of the blade.

17. The fluid-coupling device of claim 16, wherein each of the plurality of stator blades comprises a maximum thickness and a minimum thickness between the first curved surface and the second curved surface;
further wherein, a ratio of the maximum thickness to the minimum thickness is less than 3:1.

18. The fluid-coupling device of claim 17, wherein the ratio is between 2:1 and 3:1.

19. The fluid-coupling device of claim 17, wherein the trailing edge comprises a thickness that is less than 3 times thinner than the maximum thickness.

20. The fluid-coupling device of claim 17, wherein the thickness of the trailing edge is approximately 2-2.5 times thinner than the maximum thickness.
